(19) United States
(12) Patent Application Publication
(10) Pub. No.: US 2020/0149252 A1
(43) Pub. Date: May 14, 2020

(54) ROTARY CONTROL STRUCTURE FOR WATER VALVE

(71) Applicant: Greatness Sanitary Industrial Co., Ltd, Xiushui Township (TW)

(72) Inventor: Wei-Cheng Chung, Changhua County (TW)

(21) Appl. No.: 16/188,461

(22) Filed: Nov. 13, 2018

(51) Int. Cl. E03C 1/04; F16K 31/58

(52) U.S. Cl. CPC E03C 1/0404; F16K 31/58

(57) ABSTRACT

A rotary control structure for a water valve contains: a body, a connection disk, a guide disc, a guide disc, and a stop ring. The body accommodates a control shaft and includes a receiving space and an outlet. The connection disk is connected with a positioning disc including a sector cutout. The guide disc is mounted below the positioning disc and includes a fan-shaped aperture corresponding to the sector cutout. The stop ring is mounted below the fan-shaped aperture and limits the connection disk, the positioning disc, and the guide disc in the receiving space. The body includes a limitation slot, and the control shaft includes a fixing portion and a C-retainer fitted on the fixing portion. The control shaft further includes an insertion retained with a coupling groove of the connection disk, and the connection disk includes a rib configured to urge the positioning disc to rotate.

### FIELD OF THE INVENTION

The present invention relates to a rotary control structure for a water valve which is connected easily and quickly.

### BACKGROUND OF THE INVENTION

A conventional water valve is employed to control water supply from a faucet, for example, a control shaft on the water valve is rotated to drive a ceramics sheet to move so that water flows or stops flowing from an outlet of the water valve.

Referring to FIG. 1, the conventional water valve includes a control shaft 2 fixed in a receiving space 14 of a body 1, a positioning disc 4, a guide disc 5, and a stop ring 6 mounted on a bottom of the body 1. The control shaft 2, the positioning disc 4, the guide disc 5 are adhered by adhesive glue, and the control shaft 2 is inserted into a receiving orifice of the body 1. However, such a connection of the body 1, the control shaft 2, the positioning disc 4, and the guide disc 5 is troublesome. Furthermore, the control shaft 2, the positioning disc 4, and the guide disc 5 are not fixed securely.

The present invention has arisen to mitigate and/or obviate the afore-described disadvantages.

### SUMMARY OF THE INVENTION

The primary aspect of the present invention is to provide a rotary control structure for a water valve which is connected easily and quickly.

To obtain the above aspect, a rotary control structure for a water valve provided the present invention contains: a body, a connection disk, a guide disc, a guide disc, and a stop ring.

The body accommodates a control shaft and includes a receiving space, a lower end of the body is in connection with a water inflow end of a water pipe to guide water from the water pipe, and the body further includes an outlet defined on an intermediate section of the body.

The connection disk is connected with the control shaft and a positioning disc to urge the positioning disc to revolve, the positioning disc includes a sector cutout formed on a bottom of the positioning disc.

The guide disc is mounted below the positioning disc and includes a fan-shaped aperture corresponding to the sector cutout, wherein when the sector cutout corresponds to and communicates with the fan-shaped aperture, the water flows into the fan-shaped aperture via the sector cutout; and when the sector cutout does not communicate with the fan-shaped aperture, the water stops flowing into the fan-shaped aperture from the sector cutout.

The stop ring is mounted below the fan-shaped aperture and is configured to limit the connection disk, the positioning disc, and the guide disc in the receiving space.

The body includes a limitation slot, the control shaft is cylindrical and includes a fixing portion formed on an intermediate section of the control shaft, the control shaft includes a C-retainer fitted on the fixing portion, wherein the control shaft is pushed downward to the body and is connected with the body by using the C-retainer, the control shaft further includes an insertion formed on a bottom of the control shaft and retained with a coupling groove of the connection disk, and the connection disk includes a rib extending from a bottom thereof so as to urge the positioning disc to rotate.

### BRIEF DESCRIPTION OF THE DRAWINGS

FIG. 1 is a cross sectional view of a conventional rotary control structure for a water valve.

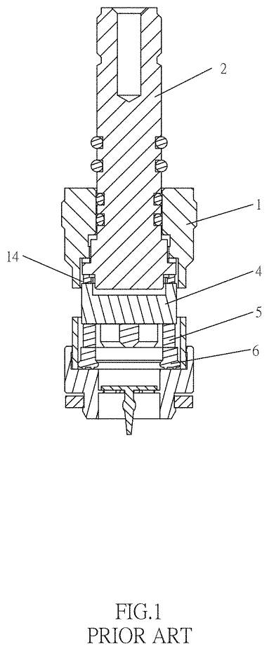

FIG. 2 is a perspective view showing the exploded components of a rotary control structure for a water valve according to a preferred embodiment of the present invention.

FIG. 3 is a perspective view showing the assembly of the rotary control structure for the water valve according to the preferred embodiment of the present invention.

FIG. 4 is a cross sectional view showing the assembly of the rotary control structure for the water valve according to the preferred embodiment of the present invention.

FIG. 5 is a cross-sectional perspective view showing the assembly of the rotary control structure for the water valve according to the preferred embodiment of the present invention.

### DETAILED DESCRIPTION OF THE PREFERRED EMBODIMENTS

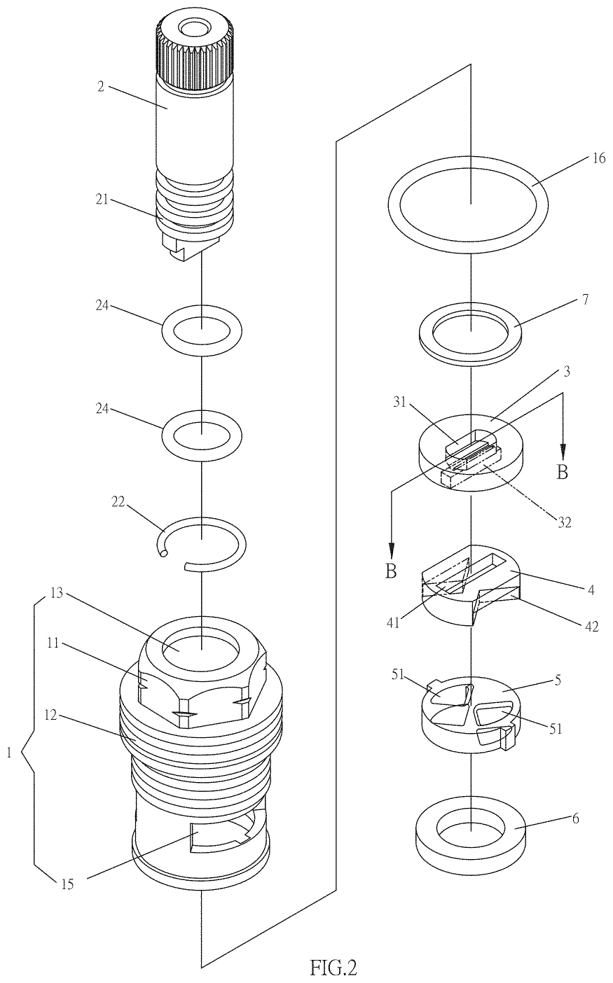

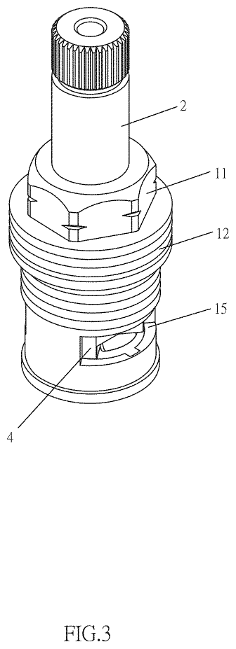

With reference to FIGS. 2-5, a rotary control structure for a water valve according to a preferred embodiment of the present invention comprising:

A body 1, a control shaft 2, a connection disk 3, a positioning disc 4, a guide disc 5, and a stop ring 6.

Referring to FIGS. 2-4, the body 1 includes a drive section 11 formed in a hexagon shape on a top of the body 1 and configured to connect with a hand tool, a threaded section 12 formed below the drive section 11 and configured to screw with a faucet so that the hand tool operates the drive section 11 to screw the body 1 with the faucet. The body 1 further includes a through orifice 13 defined on a central portion thereof and configured to accommodate the control shaft 2, wherein the body 1 further includes a receiving space 14 defined below and being coaxial with the through orifice 13, wherein a diameter of the receiving space 14 is more than the through orifice 13, such that the receiving space 14 accommodates the connection disk 3, the positioning disc 4, the guide disc 5, and the stop ring 6. The body 1 further includes an outlet 15 defined on an outer wall of an intermediate section of the body 1 so as to guide water to a water outflow end of the faucet, wherein a lower end of the body 1 is in connection with a water inflow end of a water pipe. Furthermore, the body 1 includes a washer 16 fitted on a lower end of the threaded section 16 so as to stop a water leakage, when the body 1 is screwed with the faucet.

As shown in FIGS. 2-4, a difference of the control shaft 2 from a conventional control shaft comprises: the through orifice 13 of the body 1 having a limitation slot 131 defined on a wall of the through orifice 131, the control shaft 2 being cylindrical and including a fixing portion 21 formed on an intermediate section of the control shaft 2 and a C-retainer 22 fitted on the fixing portion 21, such that the control shaft 2 is pushed downward to the body 1 and is connected with the body 1 by using the C-retainer 22. The control shaft 2 further includes multiple O-rings 24 fitted on the fixing portion 21 so as to stop the water and to matingly contact with the drive section 11.

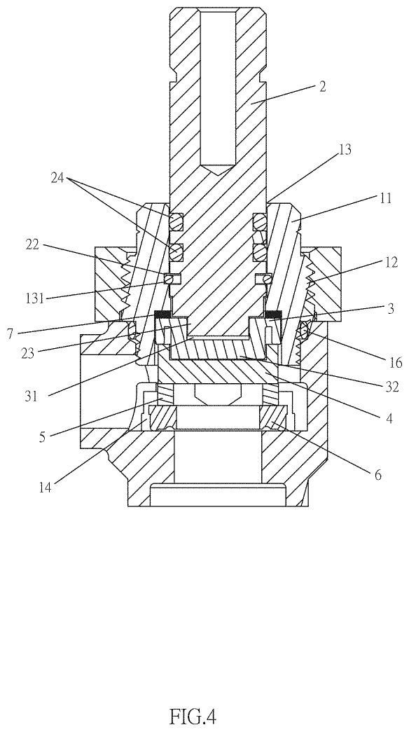

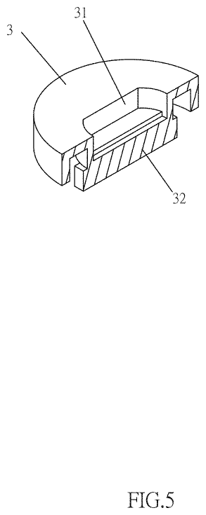

As shown in FIGS. 2, 4, and 5, the connection disk 3 is accommodated in the receiving space 14 and includes a coupling groove 31 so as to retain with an insertion 23 of a bottom of the control shaft 2, when the control shaft 2 is connection with the body 1, and the control shaft 2 drives the connection ring 3 to revolve after being rotated. As illustrated in FIGS. 4-5, the connection disk 3 includes a rib 32 extending from a bottom thereof so as to urge the positioning disc 4 to rotate.

The positioning disc 4 is coupled with the connection disk 3, wherein the positioning disc 4 includes an actuation recess 41 defined on a top thereof and corresponding to the rib 32, and the positioning disc 4 includes a sector cutout 42 formed on a bottom thereof and configured to correspond to a fan-shaped aperture 51 of the guide disc 5, wherein when the sector cutout 42 corresponds to and communicates with the fan-shaped aperture 51, the water flows into the fan-shaped aperture 51 via the sector cutout 42; and when the sector cutout 42 does not communicate with the fan-shaped aperture 51, the water stops flowing into the fan-shaped aperture 51 from the sector cutout 42.

The stop ring 6 is mounted below the fan-shaped aperture 51 and is configured to limit the connection disk 3, the positioning disc 4, and the guide disc 5 in the receiving space 14 and to gather the water, thus avoiding the water leakage.

Since the positioning disc 4, the guide disc 5, and the stop ring 6 are well-known art, further remarks are omitted.

In assembly, as shown in FIG. 4, the connection disk 3, the positioning disc 4, and the guide disc 5 are accommodated in the receiving space 14 of the body 1. The control shaft 2 is pushed downward to and is connected with the body 1 by using the C-retainer 22, then the insertion 23 of the control shaft 2 is retained with the coupling groove 31, thus connecting the rotary control structure easily and quickly.

With reference to FIGS. 2-4, the connection disk 3 includes a wear-resistant ring 7 arranged on a top thereof to abut against a top of the receiving space 14 and to reduce damage of the connection disk 3, thus prolonging a service life of the connection disk 3.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A rotary control structure for a water valve comprising:
a body accommodating a control shaft and including a receiving space, a lower end of the body being in connection with a water inflow end of a water pipe to guide water from the water pipe, and the body further including an outlet defined on an intermediate section of the body;
a connection disk being connected with the control shaft and a positioning disc to urge the positioning disc to revolve, the positioning disc including a sector cutout formed on a bottom of the positioning disc;
a guide disc mounted below the positioning disc and including a fan-shaped aperture corresponding to the sector cutout, wherein when the sector cutout corresponds to and communicates with the fan-shaped aperture, the water flows into the fan-shaped aperture via the sector cutout; and when the sector cutout does not communicate with the fan-shaped aperture, the water stops flowing into the fan-shaped aperture from the sector cutout;
A stop ring mounted below the fan-shaped aperture and configured to limit the connection disk, the positioning disc, and the guide disc in the receiving space;
wherein the body includes a limitation slot, the control shaft is cylindrical and includes a fixing portion formed on an intermediate section of the control shaft, the control shaft includes a C-retainer fitted on the fixing portion, wherein the control shaft is pushed downward to the body and is connected with the body by using the C-retainer, the control shaft further includes an insertion formed on a bottom of the control shaft and retained with a coupling groove of the connection disk, and the connection disk includes a rib extending from a bottom thereof so as to urge the positioning disc to rotate.

2. The rotary control structure as claimed in claim 1, wherein the connection disk includes a wear-resistant ring arranged on a top thereof.

3. The rotary control structure as claimed in claim 1, wherein the positioning disc includes an actuation recess defined on a top thereof and corresponding to the rib.
